(19) United States
(12) Patent Application Publication
(10) Pub. No.: US 2025/0322707 A1
(43) Pub. Date: Oct. 16, 2025

(54) DIGITAL VEHICLE KEYS BASED IDENTIFICATION OF VEHICLE PASSENGERS

(71) Applicant: Google LLC, Mountain View, CA (US)

(72) Inventors: Nicholas Ryan Miller, New York, NY (US); Emelie Jess Ashdown, San Diego, CA (US)

(21) Appl. No.: 18/631,937

(22) Filed: Apr. 10, 2024

(51) Int. Cl. G07C 9/22; G07C 9/00; G07C 9/28; G07C 9/29

(52) U.S. Cl. CPC G07C 9/22; G07C 9/00571; G07C 9/28; G07C 9/29

(57) ABSTRACT

An automotive computing device of a vehicle may receive, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle. The automotive computing device may determine, based on the corresponding information associated with each of the plurality of digital vehicle keys, profile information for occupants of the vehicle. The automotive computing device may verify that a second vehicle is authorized to receive the corresponding profile information for each of the occupants and may, based on the second vehicle being authorized to receive the corresponding profile information for each of the occupants send the profile information for the occupants of the vehicle to the second vehicle.

### BACKGROUND

Some vehicles provide the capability for a portable computing device to use a digital vehicle key to, when authenticated, unlock a door of the vehicle, start the engine of the vehicle, or turn on the vehicle (e.g., in examples where the vehicle is a battery electric vehicle). Digital vehicle keys can define multiple levels of access based on the access profile of the digital vehicle key.

### SUMMARY

In general, techniques of this disclosure are directed to enabling a vehicle (e.g., car, truck, electric bicycle, farm equipment, airplanes, etc.) enabled with digital vehicle keys (DVKs) to use digital vehicle keys to determine information associated with occupants of the vehicle. Occupants of a vehicle, including a driver of the vehicle and one or more passengers of the vehicles, may each have a computing device that stores a digital vehicle key associated with the user of the computing device. When the occupants of the vehicle are proximate to the vehicle, the computing devices of the occupants may communicate with the vehicle to exchange information associated with the digital vehicle keys stored at the computing devices.

The vehicle may use the information associated with the digital vehicle keys to receive, retrieve, or otherwise determine information regarding each of the occupants of the vehicle. In some examples, a computing device that stores a digital vehicle key for an occupant may retrieve the occupant's profile information from memory or from an external server, and may send the occupant's profile information to the vehicle. In some examples, a computing device that stores a digital vehicle key for an occupant may send, to the vehicle, information that the vehicle may use to retrieve the occupant's profile information from an external server. The vehicle may receive or otherwise retrieve information regarding occupants of the vehicle only after receiving explicit authorization from the occupants of the vehicle, and the occupants of the vehicle may revoke such authorization at any time.

During operation of the vehicle, such as when the vehicle is being driven, the vehicle may, after receiving explicit user consent, communicate with other vehicles and to send information regarding the occupants of the vehicle to other vehicles. For example, a police vehicle may communicate with the vehicle to request that the vehicle pull over, or may communicate with the vehicle to request and receive information regarding the occupants of the vehicle, such as the identities of the occupants of the vehicle, whether any of the occupants have a firearms license, whether any of the occupants have an outstanding warrant, and the like. Sending such information to a police vehicle may enhance the safety of law enforcement officers when pulling over the vehicle by making the law enforcement officers aware of the identities of the occupants of the vehicle and any potential weapons that may be in the vehicle.

By being able to communicate with multiple computing devices each storing a digital vehicle keys, the techniques of this disclosure may enable the vehicle to determine information regarding multiple occupants of a vehicle using different digital vehicle keys associated with different occupants of the vehicle. Determining information regarding occupants of a vehicle using digital vehicle keys associated with the occupants may increase the reliability of the information regarding the occupants that are determined by the vehicle. Because digital vehicle keys often rely on a combination of secure communication protocols and cryptographic techniques for authentication, it may be difficult for a digital vehicle key associated with a user to be spoofed or otherwise misused by people other than the user associated with the digital vehicle key. As such, the vehicle may be able to better rely on a digital vehicle key associated with a user to provide accurate information regarding the user associated with the digital vehicle key, thereby enabling the vehicle to more accurately determine information regarding the occupants of the vehicle.

By being able to communicate with multiple computing devices each storing a digital vehicle keys, the techniques of this disclosure may also increase the safety of the vehicle. For instance, the vehicle may, by being able to communicate with multiple computing devices each storing a digital vehicle keys, keep track of the occupants of the vehicle, and may be able to take one or more safety actions, such as by stopping the engine of the vehicle when the vehicle determines that a passenger has fallen off of or out of the vehicle.

In some aspects, the techniques described herein relate to a method including: receiving, by one or more processors of an automotive computing device of a vehicle, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys; determining, by the one or more processors and based on the corresponding information associated with each of the plurality of digital vehicle keys, corresponding profile information for each of the occupants of the vehicle; verifying, by the one or more processors, that a second vehicle is authorized to receive the corresponding profile information for each of the occupants; and based on the second vehicle being authorized receive the corresponding profile information for each of the occupants, sending, by the one or more processors and via a wireless communication link, the corresponding profile information for each of the occupants of the vehicle to the second vehicle.

In some aspects, the techniques described herein relate to an automotive computing device of a vehicle, including: a memory; and one or more processors in communication with the memory configured to: receive, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys; determine, based on the corresponding information associated with each of the plurality of digital vehicle keys, corresponding profile information for each of the occupants of the vehicle; and send the corresponding profile information for each of the occupants of the vehicle to a second vehicle that is authorized to receive the corresponding profile information for each of the occupants.

In some aspects, the techniques described herein relate to a non-transitory computer-readable medium, encoded with instructions that, when executed by one or more processors of an automotive computing device of a vehicle, cause the one or more processors to: receive, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys; determine, based on the corresponding information associated with each of the plurality of digital vehicle keys, corresponding profile information for each of the occupants of the vehicle; verify that a second vehicle is authorized to receive the corresponding profile information for each of the occupants; and based on the second vehicle being authorized to receive the corresponding profile information, send the corresponding profile information for each of the occupants of the vehicle to the second vehicle. The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating computing devices and an automotive computing device of a vehicle, in accordance with one or more techniques of this disclosure.

FIG. 2 is a block diagram illustrating an automotive computing device of a vehicle, in accordance with one or more aspects of the present disclosure.

FIG. 3 is a conceptual diagram illustrating computing devices and an automotive computing device of a vehicle in communications with computing systems, in accordance with one or more aspects of the present disclosure.

FIG. 4 is a flow diagram illustrating example operations of an automotive computing device of a vehicle, in accordance with one or more aspects of the present disclosure.

### DETAILED DESCRIPTION

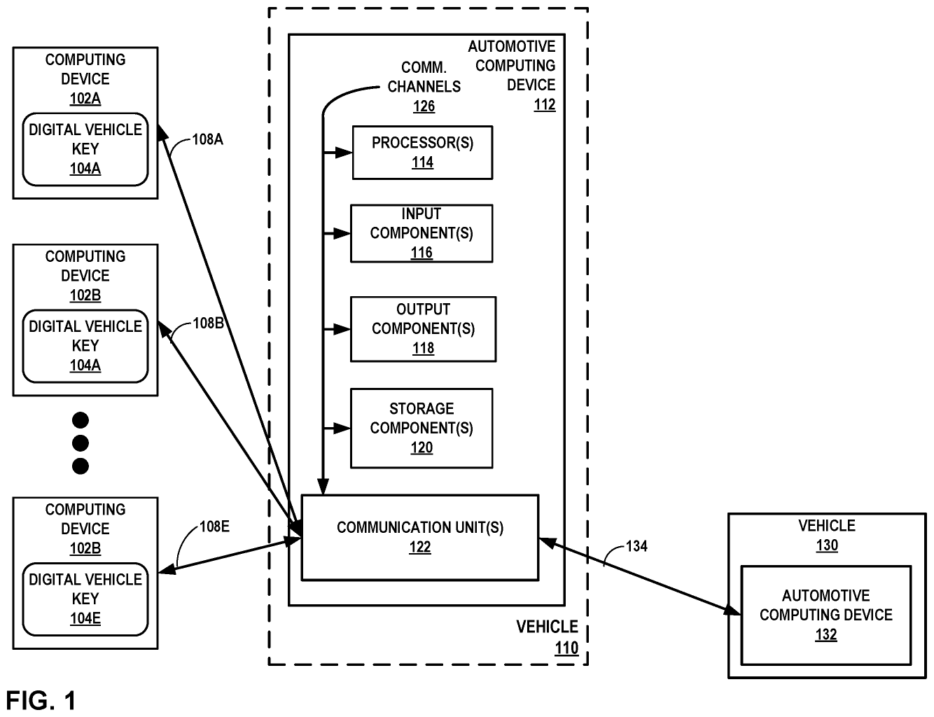

FIG. 1 is a conceptual diagram illustrating computing devices 102 and automotive computing device 112 of vehicle 110 in accordance with one or more techniques of this disclosure. As shown in FIG. 1, computing devices 102A-102E (“computing devices 102”) may include, but is not limited to, portable or mobile devices such as mobile phones (including smart phones), laptop computers, tablet computers, wearable computing devices such as smart watches or computerized eyewear, etc.

Each of computing devices 102 may be used (e.g., owned, carried, etc.) by a user and may each store a digital vehicle key of digital vehicle keys 104A-104E (“digital vehicle keys 104”) within a hardware security element of the computing device. In the example of FIG. 1, computing device 102A stores digital vehicle key 104A, computing device 102B stores digital vehicle key 104B, and computing device 102E stores digital vehicle key 104E. Each of digital vehicle keys 104 may be associated with a user. A user associated with a digital vehicle key may be a user that uses the computing device that stores the digital key. For example, digital vehicle key 104A may be associated with a user that uses computing device 102A, while digital vehicle key 104E may be associated with a user that uses computing device 102E.

Each digital vehicle key may include access profiles and other information that determines the level of access/entitlements of the digital vehicle key to a vehicle. The access profile of a digital vehicle key may determine the capabilities of the vehicle that the holder of the digital vehicle key is entitled to, such as the ability to start the vehicle.

Automotive computing device 112 may include one or more computing devices within vehicle 110 such as automotive head units, vehicle control units such as ECUs, automotive infotainment systems, integrated computing devices, and other computing devices. Automotive computing device 112 may manage or control one or more functions of vehicle 110 such as the vehicle ignition, infotainment system, navigation, EV charging, door, trunk, and frunk locks, windows, acceleration of the vehicle, top speed of the vehicle, enabling a valet mode, enabling a service mode, and other components and functionality of the vehicle.

Automotive computing device 112 includes processors 114, input components 116, output components 118, storage components 120, communication units 122, and communication channels 126 (illustrated as “COMM. CHANNELS 126” in FIG. 1).

Processors 114 may implement functionality and/or execute instructions within automotive computing device 112. Examples of processors 114 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein.

One or more input components 116 include one or more sensors. Numerous examples of sensors exist and include any input component configured to obtain environmental information about the circumstances surrounding automotive computing device 112 and/or vehicle 110. In some examples, a sensor may be an input component that obtains physical position, movement, and/or location information of automotive computing device 112 and/or vehicle 110. For instance, sensors may include one or more location sensors (GPS components, Wi-Fi components, cellular components), one or more temperature sensors, and one or more other sensors (e.g., microphone, camera, and the like). In some examples, input components 116 may include one or more components such as keyboards, mice, buttons, knobs, presence-sensitive housing and/or display, or other input components.

One or more output components 118 of automotive computing device 112 may generate output. Examples of output are tactile, audio, and video output. Output components 118 of output components 118, in one example, includes a presence-sensitive display, sound card, video graphics adapter card, speaker, liquid crystal display (LCD), or any other type of device for generating output to a human or machine.

One or more communication units 122 of automotive computing device 112 may communicate with external devices via one or more wired and/or wireless networks by transmitting and/or receiving network signals on the one or more networks. Examples of one or more communication units 122 include a network interface card (e.g. such as an Ethernet card), an optical transceiver, a radio frequency transceiver, a GPS receiver, or any other type of device that can send and/or receive information. Other examples of one or more communication units 122 may include short wave radios, cellular data radios, wireless network radios, as well as universal serial bus (USB) controllers.

One or more storage components 120 within automotive computing device 112 may store information for processing during operation of automotive computing device 112 (e.g., automotive computing device 112 may store data accessed by processors 114, input components 116, output components 118, and communication units 122 during execution at automotive computing device 112). In some examples, storage components 120 are temporary memory, meaning that a primary purpose of storage components 120 is not long-term storage. Storage components 120 on automotive computing device 112 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 120, in some examples, also include one or more computer-readable storage media. Storage components 120 may be configured to store larger amounts of information than volatile memory. Storage components 120 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories.

Automotive computing device 112 may constantly advertise, using one or more communication units 122, and via short-range communications such as BLUETOOTH Low Energy (BLE), that automotive computing device 112 is accepting digital vehicle keys. A computing device that stores a digital vehicle key may correspondingly constantly scan for advertisements from an automotive computing device that is accepting vehicle keys.

Each of computing devices 102 may be able to communicate with automotive computing device 112 to mutually authenticate the computing device and vehicle 110. A computing device may initiate communications with automotive computing device 112 of vehicle 110 in response to detecting vehicle 110 is within proximity of the computing device, such as by entering BLUETOOTH transmission range of automotive computing device 112 and detecting the advertisements broadcasted by automotive computing device 112.

When a computing device is proximate to vehicle 110 and therefore within short-range communication range of automotive computing device 112, the computing device may receive the advertisements from automotive computing device 112 and may, in response, perform a handshake with automotive computing device 112 to establish a short-range communication link, such as a BLE Bond. Such a short-range communication link may enable automotive computing device 112 and the computing device to communicate and mutually authenticate to exchange various information.

In the example of FIG. 1, vehicle 110 may have a plurality of occupants, each of which may carry, wear, or otherwise have a computing device of computing devices 102 that stores a corresponding digital vehicle key of digital vehicle keys 104. The plurality of occupants may include a driver, which is a person driving or operating vehicle 110, and one or more passengers, which are one or more people riding in or on vehicle 110 other than the driver of vehicle 110. In the example where vehicle 110 has a driver and two passengers, the driver may have computing device 102A, a first passenger may have computing device 102B, and a second passenger may have computing device 102E.

In some examples, digital vehicle keys 104 stored in computing devices 102 of the occupants of vehicle 110 may each be a digital vehicle key that has been paired with automotive computing device 112. When pairing a digital vehicle key, automotive computing device 112 may determine the access level and/or entitlements granted to the digital vehicle key, such as unlocking doors of vehicle 110 and/or starting vehicle 110. Pairing a digital vehicle key to automotive computing device 112 may enable automotive computing device 112 to confirm that the digital vehicle key is valid and may ensure that a computing device is unable to spoof the digital vehicle key. In this way, automotive computing device 112 may ensure that information associated with a digital vehicle key paired with automotive computing device 112 is reliable and is not spoofed by malicious actors.

Digital vehicle keys 104 of the occupants of vehicle 110 may have different access levels and/or entitlements. For example, digital vehicle keys 104 may include one or more digital vehicle keys that are entitled to start vehicle 110 of vehicle 110. Digital vehicle keys 104 may also include one or more digital vehicle keys that are entitled to unlock the doors of vehicle 110 but are not entitled to start vehicle 110. In some examples, digital vehicle keys 104 of the occupants of vehicle 110 may include one or more digital vehicle keys shared by the driver of vehicle 110 to the driver's passengers to enable the passengers to use their digital vehicle keys to unlock the doors of vehicle 110.

When each of computing devices 102 is proximate to vehicle 110, each of computing devices 102 proximate to vehicle 110 may initiate communications with automotive computing device 112 to establish corresponding short-range communication links 108A-108E (“short-range communication links 108”). Short-range communication link 108 may include one or more types of short-range wireless communication such as WIFI, BLUETOOTH, BLUETOOTH Low Energy (BLE), Ultra-Wideband (UWB), Near-Field Communication (NFC), among other types of communications. Short-range communication link 108 may also be secure, such as by being encrypted communication links. In the example where computing devices 102A, 102B, and 102E are within communication range with vehicle 110, computing device 102A and communication units 122 may establish short-range communication link 108A, computing device 102B and communication units 122 may establish short-range communication link 108B, and computing device 102E and communication units 122 may establish short-range communication link 108E.

In accordance with aspects of the present disclosure, automotive computing device 112 may establish short-range communication links 108 with a plurality of computing devices 102 and may receive, from computing devices 102 via corresponding short-range communication links 108, corresponding information associated with each of digital vehicle keys 104 stored in computing devices 102. Each of computing devices 102 within communication range of vehicle 110 may mutually authenticate a corresponding digital vehicle key stored in the computing device with automotive computing device 112 to establish respective short-range communication links 108 with automotive computing device 112, and may send information associated with the corresponding digital vehicle key stored in the computing device to automotive computing device 112 via a corresponding short-range communication link of short-range communication links 108. By using digital vehicle keys 104 stored in computing devices 102 to perform mutual authentication of computing devices 102 and automotive computing device 112, the techniques of this disclosure enables automotive computing device 112 and computing devices 102 to securely establish short-range communication links 108 through which automotive computing device 112 and computing devices 102 may securely communicate.

By establishing short-range communication links 108 with computing devices 102 of multiple occupants, including a driver and one or more passengers, of vehicle 110, the techniques of this disclosure enables automotive computing device 112 to receive information regarding the driver as well as passengers of vehicle 110, instead of only receiving information regarding the driver of vehicle 110. Further, by using digital vehicle keys 104 to enable automotive computing device 112 and computing devices 102 to securely establish short-range communication links 108, the techniques of this disclosure may increase the security of communications between computing devices 102 and automotive computing devices 112, and may prevent malicious entities being able to intercept and decode sensitive information that may be communicated between computing devices 102 and automotive computing device 112.

Automotive computing device 112 may receive, from each of computing devices 102 via corresponding short-range communication links 108, information associated with a corresponding digital vehicle key stored at the computing device that includes include an access profile associated with the corresponding digital vehicle key. The access profile may that indicate the level of access/entitlements to vehicle 110 to which the digital vehicle key is entitled, such as the ability to start and/or operate vehicle 110. The information associated with the corresponding digital vehicle key may also include a unique identifier for the corresponding digital vehicle key. Automotive computing device 112 may be able to use the unique identifier to, e.g., determine whether the digital vehicle key is entitled to the level of access indicated in the access profile, and to grant the digital vehicle key to the entitled level of access to vehicle 110.

Automotive computing device 112 may determine, based on the corresponding information associated with each of the corresponding plurality of digital vehicle keys 104, profile information for the occupants of vehicle 110. In some examples, as described above, automotive computing device 112 may receive profile information for the occupants of vehicle 110 from computing devices 102.

In some examples, automotive computing device 112 may receive, from each of computing devices 102 via corresponding short-range communication links 108, information associated with a corresponding digital vehicle key stored at the computing device that includes profile information of the user associated with the digital vehicle key stored at the computing device. Each of computing devices 102 may only send such profile information to automotive computing device 112 after receiving explicit consent from the user of the computing device to send such profile information to automotive computing device 112. For example, each of computing devices 102 may display a notification that indicates the profile information that is to be sent to automotive computing device 112 and that enables the user to allow or deny sending the indicated profile information to automotive computing device 112. The profile information of a user associated with a digital vehicle key that is sent to automotive computing device 112 may include personal information that is typically included in the user's driver's license, such as the user's full legal name, the user's mailing address, the user's date of birth, a physical description of the user (e.g., height, weight, eye color, etc.), and any other information related to the identity of the user. The profile information of a user may also include any other information, such as the medical records of the user, information regarding outstanding warrants of the user, information regarding any firearms licenses that the user may have obtained, information regarding the user's arrest history, and the like.

In some examples, a user associated with a digital vehicle key may enter their profile information into a computing device that stores the digital vehicle key, and the computing device may store the user's profile information in memory. In some examples, a computing device may be able to retrieve the user's profile information from one or more external servers or systems. In these examples, the computing device may, after receiving explicit consent from the user of the computing device, send the profile information of the user to automotive computing device 112 via the short-range communication link established between the computing device and automotive computing device 112.

In some examples, automotive computing device 112 may, instead of receiving profile information of a user from a computing device, receive an identifier that can be used to retrieve the profile information of the user associated with the digital vehicle key stored at the computing device. For example, computing device 102A may, after receiving explicit consent from the user of computing device 102A, send, to automotive computing device 112, an identifier that can be used by automotive computing device 112 to retrieve the profile information of the user associated with digital vehicle key 104A stored at computing device 102A. Automotive computing device 112 may receive the identifier from computing device 102A and may use the received identifier from the computing device of a user to query an external server or system to retrieve the profile information of the user from the external server or system.

The occupants of vehicle 110 may include a driver and one or more passengers. As such, automotive computing device 112 may determine driver profile information for the driver of vehicle 110 and passenger profile information for the one or more passengers of vehicle 110. To determine the driver and the one or more passengers of vehicle 110, automotive computing device 112 may determine the digital vehicle key associated with the driver of vehicle 110 out of digital vehicle keys 104, and may determine the one or more digital vehicle keys of digital vehicle keys 104 associated with a corresponding one or more passengers of vehicle 110. Automotive computing device 112 may determine that a digital vehicle key that is used to start vehicle 110 out of digital vehicle keys 104 is the digital vehicle key associated with the driver of vehicle 110. Automotive computing device 112 may also determine that the other one or more digital vehicle keys of digital vehicle keys 104 that are not used to start vehicle 110 are associated with the one or more passengers of vehicle 110.

Automotive computing device 112 may therefore determine that the driver profile information for the driver of vehicle 110 is the profile information for a user associated with the digital vehicle key used to start vehicle 110. Automotive computing devices 112 may also determine that the passenger profile information for the one or more passengers of vehicle 110 are the corresponding profile information for one or more digital vehicle keys of the occupants of vehicle 110 that were not used to start vehicle 110.

Automotive computing device 112 may send the corresponding profile information for each of the occupants of vehicle 110 to a second vehicle that is authorized to receive the profile information for the occupants of vehicle 110. Automotive computing device 112 may use one or more communication units 122 to broadcast advertisements for other vehicles to establish a wireless communication link with automotive computing device 112. For example, automotive computing device 112 may advertise the availability for an unencrypted BLUETOOTH connection to enable other vehicles to discover and connect to automotive computing device 112 via a BLUETOOTH connection. The advertisements may include identifying information associated with vehicle 110, such as the make and model of vehicle 110, the color of vehicle 110, the license plate number of vehicle 110, and the like. By including or indication such identifying information in the advertisements, automotive computing device 112 may provide a way to identify, out-of-band, vehicle 110 that is advertising the connection, thereby enabling a driver of another vehicle to verify whether the broadcasted advertisements are from a particular vehicle and to verify that their vehicle is establishing a communication link with the intended vehicle.

In this way, by including or indication identifying information associated with vehicle 110 in the advertisements, the techniques of this disclosure may reduce the number of erroneous connections made by automotive computing devices of other vehicles to automotive computing device 132, which may reduce the amount of data packets that automotive computing device 132 may have to process. Reducing the amount of data packets that automotive computing device 132 may have to process may reduce the usage of processors 114. In examples where vehicle 110 is an electric vehicle, reducing the usage of processors 114 may reduce the power consumption of automotive computing device 132, which may extend the milage range of vehicle 110.

Vehicle 130 may move into communication range of vehicle 110 and automotive computing device 132 of vehicle 130, which is similar to automotive computing device 112 of vehicle 110 may detect the advertisements broadcasted by automotive computing device 112. Automotive computing device 132 may, based on the advertisements broadcasted by automotive computing device 112, establish wireless communication link 134 with automotive computing device 112 to send and receive information to and from automotive computing device 112. Such a wireless communication link 134 may be a BLUETOOTH link or another suitable wireless communication link.

In some examples, vehicle 130 may be a law enforcement vehicle, such as a police car, that establishes wireless communication link 134 with automotive computing device 112 to communicate with automotive computing device 112. Automotive computing device 132 of the vehicle 130 may communicate with automotive computing device 112 in ways that allow automotive computing device 112 to verify that automotive computing device 112 is communicating with a vehicle, such as an official law enforcement vehicle, that is authorized to receive profile information for the occupants of vehicle 110. For example, automotive computing device 132 may provide a digital signature along with messages sent to automotive computing device 112 via wireless communication link 134, and automotive computing device 112 may use a cryptographic key that is associated with law enforcement to verify whether the digital signature indicates that the messages are being sent from a law enforcement vehicle.

In some examples, vehicle 130 may use wireless communication link 134 with automotive computing device 112 to send a request for vehicle 110 to pull over and stop. Automotive computing device 112 may, in response to receiving the message, notify the driver of the request to pull over. For example, automotive computing device 112 may output the message at one or more output devices, such as by outputting an audio notification or message (e.g., a voice message) using speakers of vehicle 110 or by displaying a notification or message on the infotainment screen of vehicle 110. In some examples, automotive computing device 112 may also communicate with the driver of vehicle 110's computing device to send a notification to the driver's computing device.

Automotive computing device 112 may also use wireless communication link 134 with automotive computing device 132 to send messages to automotive computing device 132 of vehicle 130. For example, automotive computing device 112 may, in response to receiving the request to pull over from automotive computing device 132, send a message to automotive computing device 132 acknowledging the request and indicating that the driver will pull over at the next safe area to do so.

In some examples, automotive computing device 112 may indicate, in the message that is sent to automotive computing device 132, a location where the driver intends to stop. For example, automotive computing device 112 may include Global Positioning System (GPS) coordinates or a description of a location (e.g., “the gas station at the next exit”) in the message. Automotive computing device 112 may enable the driver of vehicle 110 to select the location that is indicated in the message to be sent to automotive computing device 132. For example, automotive computing device 112 may display a map, which may be part of automotive computing device 112's navigation software, that enables the driver to select a particular location (e.g., a gas station at the next exit) where the driver intends to pull over that is indicated in the message sent to the law enforcement vehicle.

In some examples, vehicle 130 may also send a request to automotive computing device 112 for information regarding the occupants (e.g., the driver and/or passengers) of vehicle 110. The request for information may include a request for the name of the driver of vehicle 110, names of the passengers of vehicle 110, information included in the driver license of the driver, outstanding warrants of the occupants of vehicle 110, firearms licenses (e.g., concealed carry licenses) of the occupants of vehicle 110, arrest histories of the occupants of vehicle 110, and the like. The request may be in a form of a query, such as a query for the names of all occupants or a query for the names of all occupants having a firearms license.

Automotive computing device 112 may verify that vehicle 130 is authorized to receive information regarding the occupants of vehicle 110 before sending information regarding the occupants of vehicle 110 to automotive computing device 132. Automotive computing device 112 may receive the request for information regarding the driver and/or passengers of vehicle 110 and may determine whether the request was sent by a vehicle that is authorized to receive information regarding the occupants of vehicle 110. For example, automotive computing device 112 may verify that a digital signature received from automotive computing device 132 indicates that vehicle 130 is authorized to receive information regarding the occupants of vehicle 110. Automotive computing device 112 may, in response to successfully verifying that vehicle 130 is authorized to receive information regarding the occupants of vehicle 110, determine the requested information from the profile information associated with occupants of vehicle 110 and may send the requested information to automotive computing device 132.

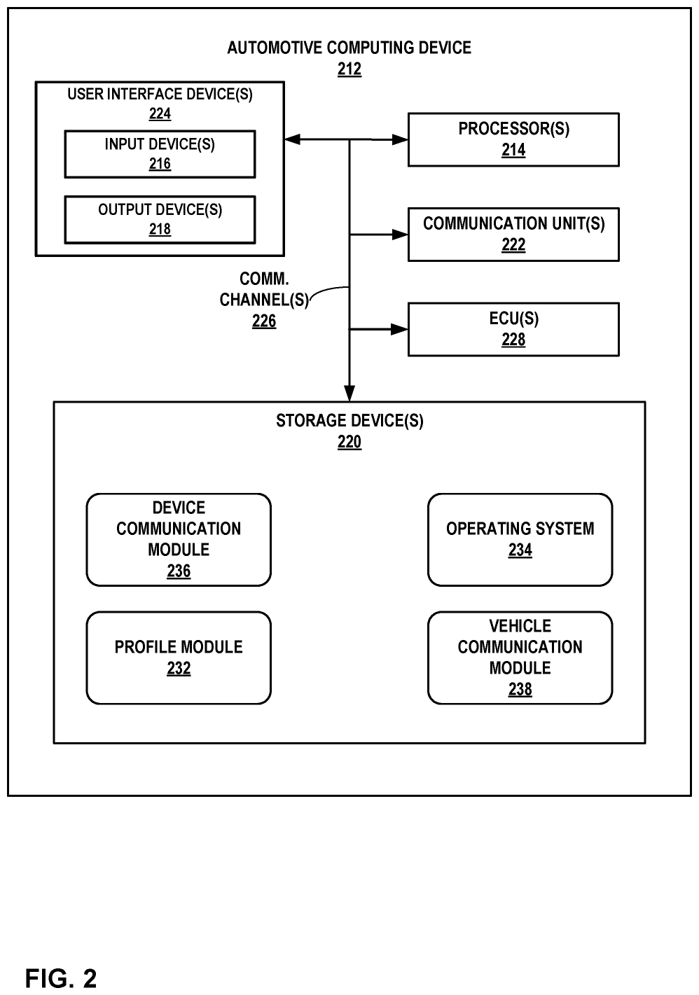

FIG. 2 is a block diagram illustrating an automotive computing device, in accordance with one or more aspects of the present disclosure. Automotive computing device 212 may be a head unit, infotainment system, vehicle control unit, or other computing device integrated into a vehicle, and may be an example of automotive computing device 112 of vehicle 110 of FIG. 1. Automotive computing device 212 includes user interface device 224, one or more processors 214, communication units 222, communication channels 226 (illustrated as “COMM. CHANNELS 210” in FIG. 2), ECUs 228, and storage devices 220.

Automotive computing device 212 includes input devices 216 and output devices 218. Input devices 216 is an example of input components 116 of FIG. 1 and output devices 218 is an example of output components 118 of FIG. 1. Input devices 216 may include one or more of microphones, touchscreens, touchpads, keyboards, mice, among other input devices. Output devices 218 may include one or more receivers, displays (e.g., an infotainment screen), haptic motor drivers, among other output devices.

Communication units 222 may be an example of communication units 122 of FIG. 1 and may include one or more communication components such WIFI, BLUETOOTH, UWB, and cellular radios among other types of communication components. Communication units 222 may facilitate communication with computing devices such as computing devices of users, automotive computing devices of other vehicles, servers such as servers associated with the manufacturer of the user's computing device or the manufacturer of the vehicle, among other computing devices.

Automotive computing device 212 includes electronic control units (“ECUs”) 228. ECUs 228 may include one or more system embedding in the vehicle of automotive computing device 212 that control one or more functions and components of the vehicle. For example, automotive computing device 212 may include an ECU of ECUs 228 that controls the ignition of the vehicle. In another example, ECUs 228 control the charging system and battery management of an EV. In other examples, ECUs 228 may control the power unit (e.g., engine), the doors, the audio system, the climate control system, and the like of the vehicle.

One or more processors 214 may be an example of one or more processors 114 of FIG. 1 and may include one or more processors such as microprocessors, microcontrollers, system on a chip, automotive processors, and embedded processors, among other types of processors. One or more processors 214 may execute device communication module 236, operating system 234, profile module 232, and vehicle communication module 238.

Automotive computing device 212 includes communication channels 226 (illustrated as “COMM. CHANNELS 226” in FIG. 2) and may be an example of communication channels 126 of FIG. 1. Communication channels 226 may facilitate communication between one or more components of automotive computing device 212 such as user interface devices 204, one or more processors 214, communication units 222, storage device 220, and ECUs 228.

One or more storage devices 220 within automotive computing device 212 may store information for processing during operation of automotive computing device 212 (e.g., automotive computing device 212 may store data accessed by user interface devices 224, one or more processors 214, ECUs 228, and communication units 222 during execution at automotive computing device 212). In some examples, storage devices 220 are temporary memory, meaning that a primary purpose of storage devices 220 is not long-term storage. Storage devices 220 on automotive computing device 212 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 220, in some examples, also include one or more computer-readable storage media. Storage devices 220 may be configured to store larger amounts of information than volatile memory. Storage devices 220 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage devices 220 may include operating system 234, profile module 232, device communication module 236, and vehicle communication module 238.

As shown in FIG. 2, storage devices 220 may include operating system 234 that provides an execution environment for one or more applications, such as profile module 232, device communication module 236, and other applications. Operating system 234 may represent a multi-threaded operating system or a single-threaded operating system. Operating system 234 may include a kernel that facilitates access to the underlying hardware of automotive computing device 212, where the kernel may present a number of different interfaces (e.g., application programmer interfaces—APIs) that profile module 232, device communication module 236, vehicle communication module 238, and other applications may invoke to access the underlying hardware of automotive computing device 212.

In accordance with aspects of this disclosure, one or more processors 214 are configured to execute device communication module 236 to establish communication links with computing devices that have digital vehicle keys and are proximate to automotive computing device 212. Device communication module 236 may broadcast, using communication units 222, and via short-range communications such as BLE, advertisements that automotive computing device 212 is accepting digital vehicle keys. Device communication module 236 may receive, using communication units 222, responses to the advertisements from a plurality of computing devices (e.g., computing devices 102 of FIG. 1) that store a corresponding plurality of digital vehicle keys (e.g., digital vehicle keys 104 of FIG. 1) that are requests from the computing devices to establish corresponding short-range communication links with automotive computing device 212. Device communication module 236 may, in response to receiving the responses from the computing devices, authenticate the digital vehicle keys stored in computing device. For example, device communication module 236 may verify that each of the digital vehicle keys is paired or otherwise known to automotive computing device 212. Device communication module 236 may, upon successful authentication of the digital vehicle keys, establish corresponding short-range communication links (e.g., corresponding short-range communication links 108 of FIG. 1) with the computing devices that store the digital vehicle keys.

One or more processors 214 are configured to execute device communication module 236 to receive, from the computing devices using communication units 222 and via the corresponding short-range communication links, corresponding information associated with each of digital vehicle keys stored in the computing devices. For example, each of the computing devices may, after receiving explicit authorization from users of the computing devices, send information associated with a corresponding digital key stored at the computing device to automotive computing device 212. Device communication module 236 may receive, from each of the computing devices via a corresponding short-range communication link, information associated with a corresponding digital vehicle key stored at the computing device that includes include an access profile associated with the corresponding digital vehicle key. The access profile may that indicate the level of access/entitlements to the vehicle to which the digital vehicle key is entitled, such as the ability to start and/or operate the vehicle. The information associated with the corresponding digital vehicle key may also include a unique identifier for the corresponding digital vehicle key. Device communication module 236 may be able to use the unique identifier to, e.g., determine whether the digital vehicle key is entitled to the level of access indicated in the access profile, and to grant the digital vehicle key to the entitled level of access to the vehicle.

A digital key stored in a computing device may be associated with the user of the computing device, and the information associated with a corresponding vehicle key stored at a computing device may include profile information of a user associated with the corresponding vehicle key. The profile information of a user associated with a digital vehicle key may include personal information that is typically included in the user's driver's license, such as the user's full legal name, the user's mailing address, the user's date of birth, a physical description of the user (e.g., height, weight, eye color, etc.), and any other information related to the identity of the user. The profile information of a user may also include any other information, such as the medical records of the user, information regarding outstanding warrants of the user, information regarding any firearms licenses that the user may have obtained, information regarding the user's arrest history, and the like.

Each computing device that has established a corresponding short-range communication link with automotive computing device 212 may, if explicitly authorized by the user associated with the digital vehicle key, send information associated with a corresponding digital vehicle key stored at the computing device that includes profile information of the user associated with the digital vehicle key. In some examples, the user associated with the digital vehicle key may explicitly select the particular profile information of the user associated with the digital vehicle key that is sent to automotive computing device 212. Device communication module 236 may therefore receive, from each computing device, information associated with a corresponding digital vehicle key stored at the computing device that includes profile information of the user associated with the digital vehicle key.

In some examples, device communication module 236 may, instead of receiving profile information of a user from a computing device, receive an identifier that can be used to retrieve the profile information of the user associated with the digital vehicle key stored at the computing device. The computing device may, after receiving explicit authorization from the user of the computing device, send such an identifier to automotive computing device 212. One or more processors 214 may therefore, in response to receiving the identifier, execute profile module 232 to communicate with one or more external systems to retrieve the profile information of the user using the received identifier.

One or more processors 214 may execute profile module 232 to determine, based on the corresponding information associated with each of the plurality of digital vehicle keys received from the computing devices, driver profile information for the driver of the vehicle and passenger profile information for the one or more passengers of vehicle. To determine the driver and the one or more passengers of the vehicle, profile module 232 may determine the digital vehicle key associated with the driver of the vehicle and may determine one or more digital vehicle keys of digital vehicle keys associated with a corresponding one or more passengers of the vehicle. Profile module 232 may determine that a digital vehicle key that is used to start the vehicle is the digital vehicle key associated with the driver of the vehicle. Profile module 232 may also determine that the other one or more digital vehicle keys that are not used to start the vehicle are associated with the one or more passengers of the vehicle.

Automotive computing device 212 may therefore determine that the driver profile information for the driver of the vehicle is the profile information for a user associated with the digital vehicle key used to start the vehicle. Profile module 232 may also determine that the passenger profile information for the one or more passengers of the are the corresponding profile information for one or more digital vehicle keys of the occupants of the vehicle that were not used to start the vehicle.

One or more processors 214 are configured to execute vehicle communication module 238 to send the driver profile information for the driver and the passenger profile information for each of the one or more passengers to a second vehicle that is authorized to receive profile information for occupants of the vehicle. Vehicle communication module 238 may broadcast, using communication units 222, advertisements for other vehicles to establish a communication link with automotive computing device 212. For example, vehicle communication module 238 may advertise the availability for an unencrypted BLUETOOTH connection to enable other vehicles to discover and connect to automotive computing device 212 via a BLUETOOTH connection. The advertisements may include identifying information associated with the vehicle of automotive computing device 212, such as the make and model of the vehicle, the color of the vehicle, the license plate number of the vehicle, and the like. Such identifying information may enable another vehicle to verify that it is establishing a communication link with the correct vehicle.

Automotive computing device 212 may verify that a second vehicle is authorized to receive information regarding the occupants of the vehicle associated with automotive computing device 212 before sending such information to the second vehicle. In some examples, vehicle communication module 238 may receive, via communication units 222, information from a second vehicle that vehicle communication module 238 may use to verify whether the second vehicle is authorized to receive information regarding the occupants of the vehicle of automotive computing device 212. For example, vehicle communication module 238 may receive, from the automotive computing device of a second vehicle, a digital signature, and vehicle communication module 238 may use a cryptographic key that is associated with vehicles authorized to receive information regarding the occupants of the vehicle of automotive computing device 212 to verify whether the digital signature indicates that the second vehicle is authorized to receive information regarding the occupants of the vehicle of automotive computing device 212.

In another example, automotive computing device 212 may designate a pre-established passphrase for other vehicles that are authorized to receive information regarding the occupants of the vehicle of automotive computing device 212. In this example, vehicle communication module 238 may receive a passphrase from the automotive computing device of a second vehicle. Vehicle communication module 238 may determine whether the received passphrase matches the pre-established passphrase. If vehicle communication module 238 determines that the received passphrase matches the pre-established passphrase, vehicle communication module 238 may determine that the second vehicle is authorized to receive information regarding the occupants of the vehicle of automotive computing device 212.

Automotive computing device 212 may also request affirmative approval from occupants of the vehicle associated with automotive computing device 212 before sending information regarding the occupants to a second vehicle. Vehicle communication module 238 may receive, from an automotive computing device associated with a second vehicle, a request for information regarding the occupants of the vehicle associated with automotive computing device 212. Device communication module 236 may, in response, send a request to each of the computing devices of the occupants for permission to send the requested information regarding the occupants to the automotive computing device of the second vehicle. Automotive computing device 102 may, in response to receiving approval from a computing device of an occupant of vehicle 110, send information regarding the occupant to automotive computing device 132. If automotive computing device 102 receives a denial of approval from a computing device of an occupant of vehicle 110, computing devices 102 may refrain from sending information regarding the occupant to automotive computing device 132.

In some examples, vehicle communication module 238 may use communication units 222 to establish a communication link with the automotive computing device of a law enforcement vehicle, such as a police car. Vehicle communication module 238 may receive, from the automotive computing device of a law enforcement vehicle, information that vehicle communication module 238 may use to verify that the law enforcement vehicle is actually associated with law enforcement and therefore authorized to receive information regarding the occupants of the vehicle associated with automotive computing device 212. For example, vehicle communication module 238 may receive, from the automotive computing device of the law enforcement vehicle, a digital signature along with messages, and vehicle communication module 238 may use a cryptographic key that is associated with law enforcement to verify whether the digital signature indicates that the messages are being sent from an official law enforcement vehicle.

In some examples, an emergency services vehicle, such as an ambulance or a fire truck, may establish a wireless communication link with automotive computing device 212 to send and receive various safety information. For example, the emergency services vehicle may send a request for information regarding the occupants of the vehicle, such as the medical records or other medical information of the occupants, whether there are any young children or infants in the vehicle, and the like. Vehicle communication module 238 may be able to receive the request for safety information, determine the requested safety information as well as whether the occupants have given explicit consent to send such safety information to an emergency services vehicle, and may, based on the occupants having given explicit consent to send such safety information to an emergency services vehicle, send the requested safety information to the emergency services vehicle.

In some examples, the profile information associated with the occupants of the vehicle received by automotive computing device 212 may include the medical records of the occupants. In some examples, profile module 232 may, after receiving explicit consent by the occupants, determine the medical information (e.g., blood type, medical history, current medications, etc.) associated with the occupants of vehicle 110 by using profile information associated with the occupants of vehicle 110 (e.g., name, date of birth, etc.) to query a medical records system for such medical information. Profile module 232 may therefore receive the medical information of the occupants from the medical records system, and vehicle communication module 238 may send such medical information to automotive computing device 132.

In some examples, an emergency services vehicle may communicate with automotive computing device 212 to determine the conditions of the occupants of the vehicle associated with automotive computing device 212. For example, if the vehicle associated with automotive computing device 212 is involved in an accident, an emergency services vehicle may send a query regarding the condition of the occupants of the vehicle to automotive computing device 212.

Vehicle communication module 238 may receive the query from the emergency services vehicle and operating system 234 may, in response to receiving the query, output the query receive from the emergency services vehicle, such as by outputting a voice message indicative of the query using speakers of the vehicle or by displaying a message indicative the query on the infotainment screen of the vehicle. In some examples, device communication module 236 may send notifications indicative of the query to the computing devices of the occupants of the vehicle. Device communication module 236 may receive responses to the query from the occupants of the vehicle. For example, occupants of the vehicle may speak about their conditions, and automotive computing device 112 may use one or more microphones to receive the spoken messages from the occupants. In another example, occupants of the vehicle may provide input at their computing devices regarding their condition, and device communication module 236 may receive indications of the occupants' condition from the occupants' computing devices. Vehicle communication module 238 may therefore forward the indications of the condition of occupants of the vehicle to the emergency services vehicle.

An emergency services vehicle may communicate with automotive computing device 212 to receive any other relevant information that may be useful to emergency service workers. For example, an emergency services vehicle may query automotive computing device 212 for sensor data, which may include vehicle sensor data such as g-forces of an impact suffered by the vehicle associated with automotive computing device 212, device sensor data, which may include sensor data collected from computing devices of the occupants of the vehicle, and the like. Such sensor data may be useful for determining the severity of an accident suffered the vehicle and for assessing the wellbeing of occupants of the vehicle.

Vehicle communication module 238 may receive a query for sensor data from an emergency services vehicle, and automotive computing device 212 may collect or otherwise determine the requested sensor data. For example, operating system 234 may retrieve vehicle sensor data, which may be collected by sensors (not shown) of automotive computing device 212 and stored in one or more storage devices 220 of automotive computing device 212. Vehicle communication module 238 may also communicate with computing devices of accounts of the vehicle to receive sensor data collected by the occupant's computing devices, such as motion data (e.g., accelerometer data, gyro data, etc.). Vehicle communication module 238 may therefore send the requested sensor data to the emergency services vehicle.

In examples where the vehicle associated with automotive computing device 212 is a truck that is carrying potentially hazardous material, automotive computing device 212 may store, in one or more storage devices 220, information about the cargo being carried by the vehicle, such as the type of cargo, weight of cargo, whether the cargo is flammable or otherwise dangerous, and the like. An emergency services vehicle, such as a fire truck, may communicate automotive computing device 212 to receive information regarding the cargo being carried by the vehicle to determine whether the vehicle is carrying potentially dangerous or hazardous material. For example, an emergency services vehicle may query automotive computing device 212 for information on the cargo being carried by the vehicle. Vehicle communication module 238 may receive the query and automotive computing device 212 may, in response to receiving the query, determine the requested information about the cargo, such as by retrieving the information from one or more storage devices 220. In some examples, automotive computing device 212 may also use sensors of the vehicle, such as weight sensors, to determine the amount and/or weight of the cargo being carried by the vehicle. Vehicle communication module 238 may therefore send the requested information to the emergency services vehicle.

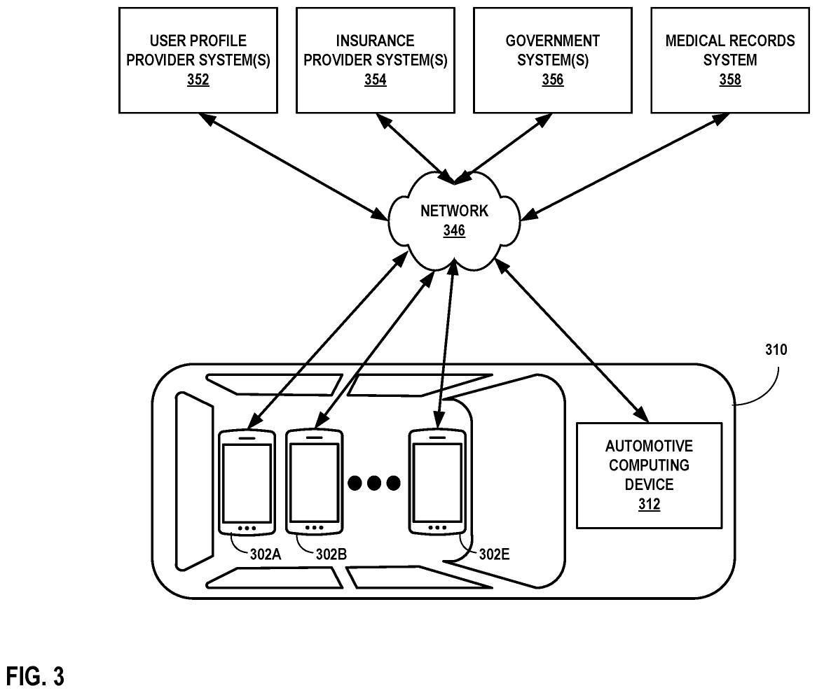

FIG. 3 is a conceptual diagram illustrating computing devices and an automotive computing device of a vehicle in communications with computing systems, in accordance with one or more aspects of the present disclosure. As shown in FIG. 3, vehicle 310, which is an example of vehicle 110 of FIG. 1, includes automotive computing device 312, which is an example of automotive computing device 112 of FIG. 1 and automotive computing device 212 of FIG. 2. Automotive computing device 312 may communicate with computing devices 302A-302E (“computing devices 302”), which are examples of computing devices 102 shown in FIG. 1. Automotive computing device 312 may also connect to and communicate with one or more user profile provider systems 352, insurance provider system 354, one or more government systems 546, and medical records system 358 via network 346. Similarly, computing devices 302 may also connect to one or more user profile provider systems 352, insurance provider system 354, one or more government systems 546, and medical records system 358 via network 346.

Network 346 may be any suitable network that enables communication between automotive computing device 312, one or more user profile provider systems 352, insurance provider system 354, one or more government systems 356, and medical records system 358. Network 346 may include a wide-area network such as the Internet, a local-area network (LAN), a personal area network (PAN) (e.g., Bluetooth®), an enterprise network, a wireless network, a cellular network, a telephony network, a Metropolitan area network (e.g., WIFI, WAN, WiMAX, etc.), one or more other types of networks, or a combination of two or more different types of networks (e.g., a combination of a cellular network and the Internet).

Insurance provider system 354 may be any system owned or controlled by an insurance provider for drivers of vehicles, and drivers insured by the insurance provider may explicitly authorize insurance provider system 354 to send, receive, and/or store data associated with the drivers. One or more government systems 356 may be any system owned or controlled by local, state, or federal governments with which automotive computing device 312 may communicate after receiving explicit authorization from a driver or other occupants of vehicle 310. Medical records system 358 may be any system owned or controlled by a hospital, a clinic, or any other medical services provider that stores medical records of users that have explicitly authorized medical records system 358 to store their medical records.

One or more user profile provider systems 352 may store profile information of users registered to digital vehicle keys. For example, a user may register a digital vehicle key associated with the user with a user profile provider system of one or more user profile provider systems 352. In some examples, as part of registering a digital vehicle key associated with the user with a user profile provider system, the user may provide profile information of the user to the user profile provider system, such as the user's full legal name, the user's mailing address, the user's date of birth, a physical description of the user (e.g., height, weight, eye color, etc.), and any other information related to the identity of the user, and may explicitly authorize the user profile provider system to store profile information of the user.

In some examples, the user may also enable and explicitly authorize the user profile provider system to access information of the user that are stored at one or more government systems 356. Such information of the user stored at one or more government systems 356 may include information regarding outstanding warrants of the user, information regarding any firearms licenses that the user may have obtained, information regarding the user's arrest history, and the like. In some examples, the user may also enable and explicitly authorize the user profile provider system to access medical information of the user that are stored at medical records system 358. Such medical information of the user stored at medical records system 358 may include the user's blood type, the user's medical history, medication currently being taken by the user, medical conditions of the user, and the like.

One or more user profile provider systems 352, insurance provider system 354, one or more government systems 356, and medical records system 358 may each be may be any suitable remote computing system, such as one or more desktop computers, laptop computers, mainframes, servers, cloud computing systems, virtual machines, etc. capable of sending and receiving information via network 346. In some examples, one or more user profile provider systems 352, insurance provider system 354, one or more government systems 356, and/or medical records system 358 may each represent a cloud computing system that provides one or more services via network 357. That is, in some examples, one or more user profile provider systems 352, insurance provider system 354, one or more government systems 356, and/or medical records system 358 may each be a distributed computing system. One or more computing devices, such as automotive computing device 312, may access the services provided by the cloud by communicating with one or more user profile provider systems 352, insurance provider system 354, one or more government systems 356, and/or medical records system 358.

Each of computing devices 302 may be used by an occupant of vehicle 310 and may each store a corresponding digital vehicle key associated with the user of the computing device. When a computing device of computing devices 302 sends information associated with the corresponding digital vehicle key stored in the computing device, the computing device may include, in the information, an indication of profile information of the user associated with the corresponding digital vehicle key. The indication of profile information of the user may be the profile information or may be information that can be used by automotive computing device 312 to retrieve the profile information from one or more user profile provider systems 352.

The profile information of a user may include the user's full legal name, the user's mailing address, the user's date of birth, a physical description of the user (e.g., height, weight, eye color, etc.), and any other information related to the identity of the user. The profile information of a user may also include information such as information regarding outstanding warrants of the user, information regarding any firearms licenses that the user may have obtained, information regarding the user's arrest history, and the like.

When computing devices 302 registers corresponding digital vehicle keys with automotive computing device 312, computing device 302 and automotive computing device 312 may negotiate the types of information that is included in the profile information that is sent to or otherwise provided by computing devices 302 to automotive computing device 312. For example, automotive computing device 312 may send, to computing device 302A, an indication of the types of profile information of the user to send to automotive computing device 312, and, in response, computing device 302A may, based on the user providing explicit authorization to send the requested types of profile information of the user, send the requested types of profile information of the user to automotive computing device 312.

In some examples, computing devices 302 may only send certain types of profile information with explicit authorization of the users of computing device 302. For example, computing devices 302 may send medical records of the users to automotive computing device 312 if and only if computing devices 302 receives explicit authorization from the users of computing devices 302 to send such information to automotive computing device 312.

In some examples, a computing device may store profile information of the user associated with the corresponding digital vehicle key. In some examples, a computing device may retrieve profile information of the user associated with the corresponding digital vehicle key from one or more user profile provider systems 352. The computing device may therefore include profile information of the user associated with the corresponding digital vehicle key, as stored in computing device 302 or retrieved from one or more user profile provider systems 352, in the information associated with the corresponding digital vehicle key that is to be sent to automotive computing device 312.

In some examples, a computing device may not include, in the information associated with a corresponding digital vehicle key stored at the computing device, profile information of the user associated with the corresponding digital vehicle key. Instead, the computing device may include, in the information, an indication of profile information of the user associated with the corresponding digital vehicle key in the form of a profile identifier for the corresponding digital vehicle key that automotive computing device 312 may use to retrieve profile information of the user associated with the corresponding digital vehicle key.

A profile identifier for a digital vehicle key may be an identifier associated with the digital vehicle key that does not include the profile information of the user associated with the digital vehicle key. Instead, automotive computing device 312 may use the profile identifier to retrieve the profile information of the user associated with the corresponding digital vehicle key from one or more user profile provider systems 352. In some examples, automotive computing device 312 may, in response to receiving the profile identifier for a digital vehicle key, send a request for the profile information of the user associated with the digital vehicle key that includes the profile identifier to one or more user profile provider systems 352. Automotive computing device 312 may, in response, receive the profile information of the user associated with the digital vehicle key from one or more user profile provider systems 352.

In some examples, a profile identifier for a digital vehicle key may be a unique identifier that indicates a particular user profile provider system of one or more user profile provider systems 352 from which automotive computing device 312 may retrieve the profile information of the user associated with the digital vehicle key. For example, a profile identifier may include a username as well as an indication of a user profile provider service, and automotive computing device 312 may use such information to retrieve the profile information of the user associated with the digital vehicle key.

In some examples, a profile identifier for a digital vehicle key may be or include a cryptographic key. Automotive computing device 312 may use the cryptographic key to retrieve and/or decrypt the profile information of the user associated with the digital vehicle key. For example, when automotive computing device 312 sends a request for the profile information of the user associated with the digital vehicle key to one or more user profile provider systems 352, automotive computing device 312 may include the cryptographic key in the request. One or more user profile provider systems 352 that receives the request may be able to use the cryptographic key to authenticate the request as being from a computing device (e.g., automotive computing device 312) that is authorized by the digital vehicle key to retrieve the profile information of the user associated with the digital vehicle key. In cases where automotive computing device 312 receives the profile information of the user associated with the digital vehicle key in an encrypted form from one or more user profile provider systems 352, automotive computing device 312 may use the cryptographic key to decrypt the received profile information.

The driver of vehicle 310 may be insured by an insurance provider that may lower the insurance premiums charged to the driver if the driver demonstrates safe driving behavior. The driver may be able to demonstrate safe driving behavior by explicitly authorizing automotive computing device 312 to send driver safety data to insurance provider system 354. For, example, at the start of each trip, such as each time the driver of vehicle 310 enters or starts vehicle 310, vehicle 310 may display a message at the infotainment screen of vehicle 310 querying whether the driver would like to send driver safety data to insurance provider system 354, and vehicle 310 may only send driver safety data for the particular trip to insurance provider system 354 if the user provides explicit authorization to send driver safety data to insurance provider system 354.

Automotive computing device 312 may, based on the user providing explicit authorization to send driving safety data to insurance provider system 354, communicate with insurance provider system 354 to send and receive information related to the driver and the driving of vehicle 310. For example, automotive computing device 312 may periodically send, to insurance provider system 354, driving safety data such as the current driving speed, the amount of miles driven during a trip, the amount of time driving during the day, the amount of time driving at night, the number of speeding events (e.g., the frequency and duration of exceeding speed limits), the number of harsh maneuvering events (e.g., hard braking, rapid acceleration, sharp turns, etc.), and the like.

Automotive computing device 312 may communicate with computing devices 302 to receive information associated with a digital vehicle key of a driver of vehicle 310 and information associated with one or more digital keys of one or more passengers of vehicle 310. Automotive computing device 312 may identify the digital vehicle key being used to attempt to start vehicle 310 as the digital vehicle key of the driver of vehicle 310.

In some examples, automotive computing device 312 may, based on the occupants of vehicle 310 providing explicit authorization, send profile information associated with the driver and the one or more passengers of vehicle 310 to insurance provider system 354. The profile information associated with the one or more passengers may enable the insurance provider for the driver to gather information about the passengers that are consistently in the car with the driver to be able to more effectively price premiums for the driver driving vehicle 310.

In some examples, the driver of vehicle 310 may be associated with one or more conditions. The one or more conditions may have to be met in order for the driver to be able to operate vehicle 310. For example, if the driver is a provisional driver (e.g., a driver with a provisional instruction permit or a provisional driver license), the driver may only be able to drive if the occupants of vehicle 310 includes a passenger who is a licensed driver and who is over a certain age (e.g., over the age of 25). In another example, if the driver is a new driver, a newly-licensed driver having less than a year of driving experience, e driver may only be able to drive if the occupants of vehicle 310 includes a passenger who is a licensed driver and is related to the driver (e.g., a parent of the driver or a sibling of the driver). In another example, a driver may only be allowed to have certain people as passengers in vehicle 310.

The information associated with a digital vehicle key may include or otherwise allow automotive computing device 312 to access information that allows automotive computing device 312 to determine whether the one or more conditions associated with the driver of vehicle 310 has been met. For example, if the driver is associated with a condition of having a family member as a passenger, the information associated with the driver's digital vehicle key may include or otherwise indicate the names of the driver's family members, and the digital vehicle keys of the passengers may each indicate the name of the associated passenger. In another example, if the driver is associated with a condition of having a passenger that is over a certain age, the digital vehicle key of the passengers may each indicate the age of the associated passenger.

In some examples, automotive computing device 312 may allow the driver to use their digital vehicle key to start vehicle 110 only if automotive computing device 312 determines that the one or more conditions associated with the driver have been met. In some examples, automotive computing device 312 may allow the driver to use their digital vehicle key to start vehicle 110 regardless of whether the one or more conditions associated with the driver have been met. In any case, automotive computing device 312 may, in some examples, based on receiving explicit authorization from the driver, send an indication of whether the one or more conditions associated with the driver have been met to an external computing system, such as insurance provider system 354.

Automotive computing device 312 may receive, from the computing device of the driver, information associated with the digital vehicle key of the driver that specifies one or more conditions associated with the driver. Automotive computing device 312 may determine, based on the information associated with the digital vehicle keys of the driver and of the one or more passengers received from computing devices 302, whether the one or more conditions have been met. Automotive computing device 312 may take one or more actions based on whether the one or more conditions have been met. In some examples, the one or more conditions may not be specified by the digital vehicle key, but may instead be one or more conditions associated with vehicle 310. For example, if vehicle 310 is a rental vehicle (e.g., a rental car or a car in a car share program), vehicle 310 may require that the driver is over the age of 25.

For example, automotive computing device 312 may, in response to receiving, from a computing device that stores the digital vehicle key associated with the driver, a request to start vehicle 310. Automotive computing device 312 may, in response to receiving the request, determine whether the one or more conditions have been met (e.g., whether the driver is over the age of 25). Automotive computing device 312 may, in response to determining that the one or more conditions have been met, start the car. Automotive computing device 312 may, in response to determining that the one or more conditions have not been met, refrain from starting the car and may output a notification (e.g., for display at the infotainment screen of vehicle 310) that the one or more conditions have not been met.

In some examples, automotive computing device 312 may use an external system to determine whether one or more conditions associated with the driver of vehicle 310 have been met. As described above, computing devices 302 may send, after receiving explicit authorization from the users of computing devices 302, to automotive computing device 312, information associated with a digital vehicle key that include a profile identifier that automotive computing device 312 may use to retrieve profile information of the user of the digital vehicle key. Automotive computing device 312 may therefore receive, from computing devices 302, information associated with digital vehicle keys stored at computing devices 302 of occupants of vehicle 310 that includes profile identifiers associated with the occupants of vehicle 310.

Automotive computing device 312 may communicate with one or more external systems, such as one or more user profile provider systems 352, to send a query regarding whether one or more conditions associated with the driver of vehicle 310 have been met. The query may include or indicate the one or more preconditions associated with the driver as well as the profile identifiers associated with the occupants of vehicle 310.

One or more user profile provider systems 352 may receive the query from automotive computing device 312. One or more user profile provider systems 352 may, in response, use the profile identifiers associated with the occupants of vehicle 310 to determine whether the driver of vehicle 310 is associated with one or more conditions and whether the one or more conditions have been met. One or more user profile provider systems 352 may send an indication of whether the one or more conditions have been met to automotive computing device 312.

Automotive computing device 312 may receive, from one or more user profile provider systems 352, the indication of whether the one or more conditions associated with the driver of vehicle 310 have been met. Automotive computing device 312 may, in response to receiving an indication that the one or more conditions have been met, start the car. Automotive computing device 312 may, in response to receiving an indication that the one or more conditions have not been met, refrain from starting the car and may output a notification (e.g., for display at the infotainment screen of vehicle 310) that the one or more conditions have not been met.

Automotive computing device 312 may, after receiving explicit authorization from the occupants of vehicle 310, act on the profile information associated with the occupants of vehicle 310 in a variety of ways to make the occupants' experience more comfortable, safe, or personalized while traveling in vehicle 310. In some examples, the profile information associated with the occupants of vehicle 310 may indicate the favorite musical artists and/or musical genres of each of occupants of vehicles 310. Automotive computing device 312 may therefore select music to be played by vehicle 310's music system from a musical artist or musical genre that is a favorite of all or a majority of occupants of vehicles 310. In another example, automotive computing device 312 may use height information indicated in the profile information associated with the occupants of vehicle 310 to automatically adjust the seats of vehicle 310.

Automotive computing device 312 may periodically communicate with computing devices 302 of occupants of vehicle 310 to keep track the number of occupants that are in vehicle 310. As described above, each computing device of computing devices 302 is associated with an occupant of vehicle 310. Automotive computing device 312 may periodically communicate with each of computing devices 302 of occupants of vehicle 310, such as by periodically pinging each of computing devices 302, or by periodically determining whether automotive computing device 312 is able to communicate with each of computing devices 302 of the occupants of vehicle 310, to keep track the number of occupants that are in vehicle 310 and/or to determine whether the number of occupants of vehicle 310 has changed. For example, if automotive computing device 312 determines, during a trip, that automotive computing device 312 is no longer able to communicate with a computing device of computing device 302, automotive computing device 312 may determine that the occupant using the computing device is no longer in vehicle 310.

In some examples, automotive computing device 312 may take one or more actions in response to determining that the number of occupants of vehicle 310 have changed during a trip. In the example where vehicle 310 is a watercraft such as a boat or a jet ski, a decrease in the number of occupants during a trip (e.g., while vehicle 310 is moving) may indicate that an occupant has fallen off or out of vehicle 310. As such, automotive computing device 312 may, in response to determining a decrease in the number of occupants during a trip, shut off vehicle 310, such as by turning off the engine of vehicle 310.

In some examples, automotive computing device 312 may, after receiving explicit authorization from the occupants of vehicle 310, communicate with one or more government systems 356 to send information associated with occupants of vehicle 310, such as profile information associated with the driver and one or more passengers of vehicle 310 to one or more government systems 356. For example, the government may install devices along highways to monitor compliance with High-Occupancy Vehicle (HOV) lane requirements, such as requiring that cars driving in HOV lanes carry at least two passengers. As such, when vehicle 310 is driving in a HOV lane and when automotive computing device 312 is within communication range of a device that monitors compliance with HOV lane requirements, automotive computing device 312 may be able to count the number of occupants in vehicle 310 and may send an indication of the number of occupants in vehicle 310 to the device that monitors compliance with HOV lane requirements. In another example, the government may charge tolls on highways depending on the number of passengers. In this example, when automotive computing device 312 is within communication range of a device that monitors the number of occupants in a vehicle, automotive computing device 312 may be able to count the number of occupants in vehicle 310 and may send an indication of the number of occupants in vehicle 310 to the device.

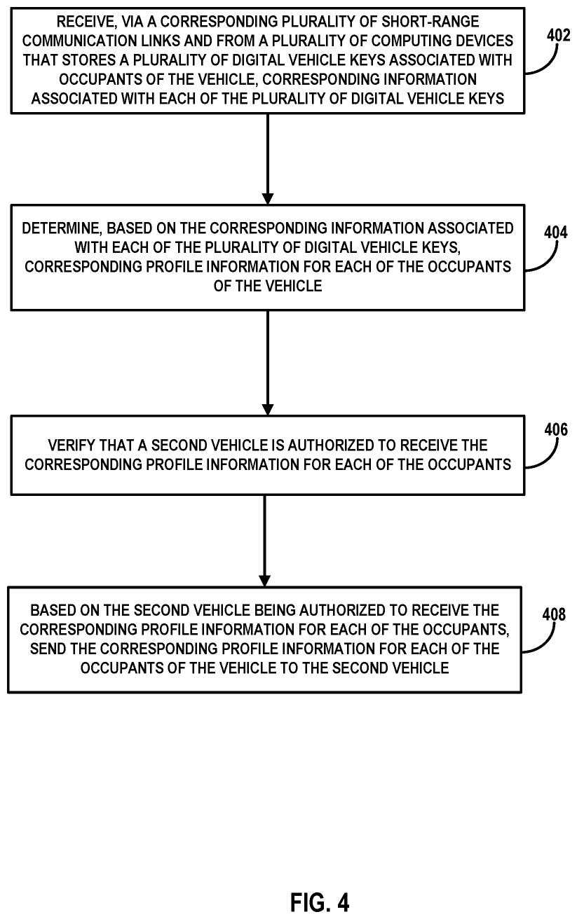

FIG. 4 is a flow diagram illustrating example operations of an automotive computing device of a vehicle, in accordance with one or more aspects of the present disclosure. For the purposes of clarity, FIG. 4 will be discussed in the context of FIGS. 1 and 2.

As shown in FIG. 4, one or more processors 214 of automotive computing device 132 of vehicle 130 may receive, via a corresponding plurality of short-range communication links 108 and from a plurality of computing devices 102 each storing a corresponding digital vehicle key of a plurality of digital vehicle keys 104 associated with occupants of the vehicle 130, corresponding information associated with each of the plurality of digital vehicle keys 104 (402).

One or more processors 214 may determine, based on the corresponding information associated with each of the plurality of digital vehicle keys 104, corresponding profile information for each of the occupants of the vehicle 130 (404).

One or more processors 214 may verify that a second vehicle 130 is authorized to receive the corresponding profile information for each of the occupants (406) and may, based on the second vehicle 130 being authorized to receive the corresponding profile information for each of the occupants, send the corresponding profile information for each of the occupants of the vehicle 110 to the second vehicle 130 (408). In some examples, to send the corresponding profile information for each of the occupants of the vehicle 110 to the second vehicle 130, one or more processors 214 may establish a wireless communication link 134 with a second automotive computing device 132 of the second vehicle 130. For example, one or more processors 214 may broadcast advertisements for other vehicles to establish wireless communication links with the vehicle, where the advertisements indicate one or more of: a make and model of the vehicle, a color of the vehicle, or a license plate number of the vehicle. The second vehicle 130 may, in response to receiving the advertisements, establish a wireless communication link 134 with vehicle 110.

One or more processors 214 may receive, from the second vehicle 130 and via the wireless communication link 134, a query for the corresponding profile information for the occupants of the vehicle 110. One or more processors 214 may, in response to receiving the query, transmit, to the second vehicle 130 via the wireless communication link 134, the corresponding profile information for each of the occupants of the vehicle 110.

In some examples, the second vehicle 130 is a law enforcement vehicle, and the corresponding profile information for each of the occupants includes information regarding one or more of: an identity of one or more of the occupants, outstanding warrants of one or more of the occupants, firearms licenses of one or more of the occupants, or an arrest history of one or more of the occupants. In some examples, to send the corresponding profile information, automotive computing device 212 may verify that the query is from law enforcement and may, in response to verifying that the query is from law enforcement, transmit, to the second vehicle 130 via the wireless communication link 134, the corresponding profile information for each of the occupants.

In some examples, the occupants of the vehicle 110 include a driver of the vehicle 110 and one or more passengers of the vehicle 110, and the corresponding profile information for the occupants of the vehicle 110 include driver profile information for the driver for the vehicle 110 and corresponding passenger profile information for the one or more passengers of the vehicle 110. In some examples, one or more processors 214 may determine, based on the driver profile information, one or more conditions associated with the driver of the vehicle 110. One or more processors 214 may determine that the one or more conditions have been met. One or more processors 214 may, in response to determining that the one or more conditions associated with the driver of the vehicle 110 have been met, enable the driver to start the vehicle 110. In some examples, to determine that the one or more conditions associated with the driver of the vehicle 110 have been met, one or more processors 214 may determine, based on the corresponding passenger profile information for the one or more passengers of the vehicle 110, that an age or a familial relationship of a passenger of the vehicle 110 meets the one or more conditions associated with the driver of the vehicle 110.

In some examples, the corresponding information associated with each of the plurality of digital vehicle keys 104 include profile identifiers associated with the occupants of the vehicle 110, and to determine the corresponding profile information for each of the occupants of the vehicle 110, one or more processors 214 may send, to an external computing system, a request for the corresponding profile information for each of the occupants of the vehicle 110 that includes the profile identifiers associated with the occupants of the vehicle 110. One or more processors 214 may, in response to sending the request, receive, from the external computing system, the corresponding profile information for each of the occupants of the vehicle 110.

In some examples, the corresponding profile information for each of the occupants of the vehicle 110 include medical records of the occupants of the vehicle 110, and the second vehicle 130 is an emergency services vehicle.

This disclosure includes the following examples.

Example 1. A method comprising: receiving, by one or more processors of an automotive computing device of a vehicle, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys; determining, by the one or more processors and based on the corresponding information associated with each of the plurality of digital vehicle keys, corresponding profile information for each of the occupants of the vehicle; verifying, by the one or more processors, that a second vehicle is authorized to receive the corresponding profile information for each of the occupants; and based on the second vehicle being authorized receive the corresponding profile information for each of the occupants, sending, by the one or more processors and via a wireless communication link, the corresponding profile information for each of the occupants of the vehicle to the second vehicle.

Example 2. The method of example 1, wherein sending the corresponding profile information for each of the occupants of the vehicle to the second vehicle further comprises: establishing, by the one or more processors, a wireless communication link with a second automotive computing device of the second vehicle; receiving, by the one or more processors and from the second vehicle via the wireless communication link, a query for the corresponding profile information for the occupants of the vehicle; and in response to receiving the query, transmitting, by the one or more processors and to the second vehicle via the wireless communication link, the corresponding profile information for each of the occupants of the vehicle.

Example 3. The method of example 2, wherein the second vehicle is a law enforcement vehicle, and wherein the corresponding profile information for each of the occupants includes information regarding one or more of: an identity of one or more of the occupants, outstanding warrants of one or more of the occupants, firearms licenses of one or more of the occupants, or an arrest history of one or more of the occupants.

Example 4. The method of example 3, wherein verifying that the second vehicle is authorized to receive the corresponding profile information for each of the occupants further comprises: verifying, by the one or more processors, that the query is from law enforcement.

Example 5. The method of any of examples 1-4, wherein the occupants of the vehicle include a driver of the vehicle and one or more passengers of the vehicle, and wherein the corresponding profile information for the occupants of the vehicle include driver profile information for the driver for the vehicle and corresponding passenger profile information for the one or more passengers of the vehicle.

Example 6. The method of example 5, further comprising: determining, by the one or more processors and based on the driver profile information, one or more conditions associated with the driver of the vehicle; determining, by the one or more processors, that the one or more conditions have been met; and in response to determining that the one or more conditions associated with the driver of the vehicle have been met, enabling, by the one or more processors, the driver to start the vehicle.

Example 7. The method of example 6, wherein determining that the one or more conditions associated with the driver of the vehicle have been met further comprises: determining, by the one or more processors and based on the corresponding passenger profile information for the one or more passengers of the vehicle, that an age or a familial relationship of a passenger of the vehicle meets the one or more conditions associated with the driver of the vehicle.

Example 8. The method of any of examples 1-7, wherein the corresponding information associated with each of the plurality of digital vehicle keys include profile identifiers associated with the occupants of the vehicle, and wherein determining the corresponding profile information for each of the occupants of the vehicle further comprises: sending, by the one or more processors and to an external computing system, a request for the corresponding profile information for each of the occupants of the vehicle that includes the profile identifiers associated with the occupants of the vehicle; and in response to sending the request, receiving, by the one or more processors and from the external computing system, the corresponding profile information for each of the occupants of the vehicle.

Example 9. The method of any of examples 1-8, wherein the corresponding profile information for each of the occupants of the vehicle include medical records of the occupants of the vehicle, and wherein the second vehicle is an emergency services vehicle.

Example 10. The method of any of examples 1-9, further comprising: broadcasting, by the one or more processors, advertisements for other vehicles to establish wireless communication links with the vehicle, wherein the advertisements indicate one or more of: a make and model of the vehicle, a color of the vehicle, or a license plate number of the vehicle.

Example 11. An automotive computing device of a vehicle, comprising: a memory; and one or more processors in communication with the memory configured to: receive, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys; determine, based on the corresponding information associated with each of the plurality of digital vehicle keys, corresponding profile information for each of the occupants of the vehicle; and send the corresponding profile information for each of the occupants of the vehicle to a second vehicle that is authorized to receive the corresponding profile information for each of the occupants.

Example 12. The automotive computing device of example 11, wherein to send the corresponding profile information for each of the occupants of the vehicle to the second vehicle, the one or more processors are further configured to: establish a wireless communication link with a second automotive computing device of the second vehicle; receive, from the second vehicle and via the wireless communication link, a query for the corresponding profile information for the occupants of the vehicle; and in response to receiving the query, transmit, to the second vehicle via the wireless communication link, the corresponding profile information for each of the occupants of the vehicle.

Example 13. The automotive computing device of example 12, wherein the second vehicle is a law enforcement vehicle, and wherein the corresponding profile information for each of the occupants includes information regarding one or more of: an identity of one or more of the occupants, outstanding warrants of one or more of the occupants, firearms licenses of one or more of the occupants, or an arrest history of one or more of the occupants.

Example 14. The automotive computing device of example 13, wherein to verify that the second vehicle is authorized to receive the corresponding profile information for each of the occupants, the one or more processors are further configured to: verify that the query is from law enforcement.

Example 15. The automotive computing device of any of examples 11-14, wherein the occupants of the vehicle include a driver of the vehicle and one or more passengers of the vehicle, and wherein the corresponding profile information for the occupants of the vehicle include driver profile information for the driver for the vehicle and corresponding passenger profile information for the one or more passengers of the vehicle.

Example 16. The automotive computing device of example 15, wherein the one or more processors are further configured to: determine, based on the driver profile information, one or more conditions associated with the driver of the vehicle; determine that the one or more conditions have been met; and in response to determining that the one or more conditions associated with the driver of the vehicle have been met, enable the driver to start the vehicle.

Example 17. The automotive computing device of example 16, wherein to determine that the one or more conditions associated with the driver of the vehicle have been met, the one or more processors are further configured to: determine, based on the corresponding passenger profile information for the one or more passengers of the vehicle, that an age or a familial relationship of a passenger of the vehicle meets the one or more conditions associated with the driver of the vehicle.

Example 18. The automotive computing device of any of examples 11-17, wherein the corresponding information associated with each of the plurality of digital vehicle keys include profile identifiers associated with the occupants of the vehicle, and wherein to determine the corresponding profile information for each of the occupants of the vehicle, the one or more processors are further configured to: send, to an external computing system, a request for the corresponding profile information for each of the occupants of the vehicle that includes the profile identifiers associated with the occupants of the vehicle; and in response to sending the request, receive, from the external computing system, the corresponding profile information for each of the occupants of the vehicle.

Example 19. The automotive computing device of any of examples 11-18, wherein the corresponding profile information for each of the occupants of the vehicle include medical records of the occupants of the vehicle, and wherein the second vehicle is an emergency services vehicle.

Example 20. A non-transitory computer-readable medium, encoded with instructions that, when executed by one or more processors of an automotive computing device of a vehicle, cause the one or more processors to: receive, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys; determine, based on the corresponding information associated with each of the plurality of digital vehicle keys, corresponding profile information for each of the occupants of the vehicle; verify that a second vehicle is authorized to receive the corresponding profile information for each of the occupants; and based on the second vehicle being authorized to receive the corresponding profile information, send the corresponding profile information for each of the occupants of the vehicle to the second vehicle.

Example 21. A device comprising means for performing any combination of the methods of examples 1-10.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the embodiment, certain acts or events of any of the methods described herein may be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
receiving, by one or more processors of an automotive computing device of a vehicle, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys;
determining, by the one or more processors and based on the corresponding information associated with each of the plurality of digital vehicle keys, corresponding profile information for each of the occupants of the vehicle;
verifying, by the one or more processors, that a second vehicle is authorized to receive the corresponding profile information for each of the occupants; and
based on the second vehicle being authorized receive the corresponding profile information for each of the occupants, sending, by the one or more processors and via a wireless communication link, the corresponding profile information for each of the occupants of the vehicle to the second vehicle.

2. The method of claim 1, wherein sending the corresponding profile information for each of the occupants of the vehicle to the second vehicle further comprises:
establishing, by the one or more processors, a wireless communication link with a second automotive computing device of the second vehicle;
receiving, by the one or more processors and from the second vehicle via the wireless communication link, a query for the corresponding profile information for the occupants of the vehicle; and
in response to receiving the query, transmitting, by the one or more processors and to the second vehicle via the wireless communication link, the corresponding profile information for each of the occupants of the vehicle.

3. The method of claim 2,
wherein the second vehicle is a law enforcement vehicle, and
wherein the corresponding profile information for each of the occupants includes information regarding one or more of: an identity of one or more of the occupants, outstanding warrants of one or more of the occupants, firearms licenses of one or more of the occupants, or an arrest history of one or more of the occupants.

4. The method of claim 3, wherein verifying that the second vehicle is authorized to receive the corresponding profile information for each of the occupants further comprises:
verifying, by the one or more processors, that the query is from law enforcement.

5. The method of claim 1, wherein the occupants of the vehicle include a driver of the vehicle and one or more passengers of the vehicle, and wherein the corresponding profile information for the occupants of the vehicle include driver profile information for the driver for the vehicle and corresponding passenger profile information for the one or more passengers of the vehicle.

6. The method of claim 5, further comprising:
determining, by the one or more processors and based on the driver profile information, one or more conditions associated with the driver of the vehicle;
determining, by the one or more processors, that the one or more conditions have been met; and
in response to determining that the one or more conditions associated with the driver of the vehicle have been met, enabling, by the one or more processors, the driver to start the vehicle.

7. The method of claim 6, wherein determining that the one or more conditions associated with the driver of the vehicle have been met further comprises:
determining, by the one or more processors and based on the corresponding passenger profile information for the one or more passengers of the vehicle, that an age or a familial relationship of a passenger of the vehicle meets the one or more conditions associated with the driver of the vehicle.

8. The method of claim 1, wherein the corresponding information associated with each of the plurality of digital vehicle keys include profile identifiers associated with the occupants of the vehicle, and wherein determining the corresponding profile information for each of the occupants of the vehicle further comprises:
sending, by the one or more processors and to an external computing system, a request for the corresponding profile information for each of the occupants of the vehicle that includes the profile identifiers associated with the occupants of the vehicle; and
in response to sending the request, receiving, by the one or more processors and from the external computing system, the corresponding profile information for each of the occupants of the vehicle.

9. The method of claim 1, wherein the corresponding profile information for each of the occupants of the vehicle include medical records of the occupants of the vehicle, and wherein the second vehicle is an emergency services vehicle.

10. The method of claim 1, further comprising:
broadcasting, by the one or more processors, advertisements for other vehicles to establish wireless communication links with the vehicle, wherein the advertisements indicate one or more of: a make and model of the vehicle, a color of the vehicle, or a license plate number of the vehicle.

11. An automotive computing device of a vehicle, comprising:
a memory; and
one or more processors in communication with the memory configured to:
receive, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys;
determine, based on the corresponding information associated with each of the plurality of digital vehicle keys, corresponding profile information for each of the occupants of the vehicle; and
send the corresponding profile information for each of the occupants of the vehicle to a second vehicle that is authorized to receive the corresponding profile information for each of the occupants.

12. The automotive computing device of claim 11, wherein to send the corresponding profile information for each of the occupants of the vehicle to the second vehicle, the one or more processors are further configured to:
establish a wireless communication link with a second automotive computing device of the second vehicle;
receive, from the second vehicle and via the wireless communication link, a query for the corresponding profile information for the occupants of the vehicle; and
in response to receiving the query, transmit, to the second vehicle via the wireless communication link, the corresponding profile information for each of the occupants of the vehicle.

13. The automotive computing device of claim 12,
wherein the second vehicle is a law enforcement vehicle, and
wherein the corresponding profile information for each of the occupants includes information regarding one or more of: an identity of one or more of the occupants, outstanding warrants of one or more of the occupants, firearms licenses of one or more of the occupants, or an arrest history of one or more of the occupants.

14. The automotive computing device of claim 13, wherein to verify that the second vehicle is authorized to receive the corresponding profile information for each of the occupants, the one or more processors are further configured to:
verify that the query is from law enforcement.

15. The automotive computing device of claim 11, wherein the occupants of the vehicle include a driver of the vehicle and one or more passengers of the vehicle, and wherein the corresponding profile information for the occupants of the vehicle include driver profile information for the driver for the vehicle and corresponding passenger profile information for the one or more passengers of the vehicle.

16. The automotive computing device of claim 15, wherein the one or more processors are further configured to:
determine, based on the driver profile information, one or more conditions associated with the driver of the vehicle;
determine that the one or more conditions have been met; and
in response to determining that the one or more conditions associated with the driver of the vehicle have been met, enable the driver to start the vehicle.

17. The automotive computing device of claim 16, wherein to determine that the one or more conditions associated with the driver of the vehicle have been met, the one or more processors are further configured to:
determine, based on the corresponding passenger profile information for the one or more passengers of the vehicle, that an age or a familial relationship of a passenger of the vehicle meets the one or more conditions associated with the driver of the vehicle.

18. The automotive computing device of claim 11, wherein the corresponding information associated with each of the plurality of digital vehicle keys include profile identifiers associated with the occupants of the vehicle, and wherein to determine the corresponding profile information for each of the occupants of the vehicle, the one or more processors are further configured to:
send, to an external computing system, a request for the corresponding profile information for each of the occupants of the vehicle that includes the profile identifiers associated with the occupants of the vehicle; and
in response to sending the request, receive, from the external computing system, the corresponding profile information for each of the occupants of the vehicle.

19. The automotive computing device of claim 11, wherein the corresponding profile information for each of the occupants of the vehicle include medical records of the occupants of the vehicle, and wherein the second vehicle is an emergency services vehicle.

20. A non-transitory computer-readable medium, encoded with instructions that, when executed by one or more processors of an automotive computing device of a vehicle, cause the one or more processors to:
receive, via a corresponding plurality of short-range communication links and from a plurality of computing devices each storing a corresponding digital vehicle key of a plurality of digital vehicle keys associated with occupants of the vehicle, corresponding information associated with each of the plurality of digital vehicle keys;
determine, based on the corresponding information associated with each of the plurality of digital vehicle keys, corresponding profile information for each of the occupants of the vehicle;
verify that a second vehicle is authorized to receive the corresponding profile information for each of the occupants; and
based on the second vehicle being authorized to receive the corresponding profile information, send the corresponding profile information for each of the occupants of the vehicle to the second vehicle.
